(19) United States
(12) Patent Application Publication
(10) Pub. No.: US 2004/0138045 A1
(43) Pub. Date: Jul. 15, 2004

(54) Dielectric material for a plasma display panel

(75) Inventors: Syunsuke Komatsudani, Kusatsu-shi (JP); Hiroyuki Ohshita, Otsu-shi (JP); Masahiko Ohji, Moriyama-shi (JP); Kazuo Hadano, Otsu-shi (JP)

Correspondence Address: WILLIAM COLLARD, COLLARD & ROE, P.C., 1077 NORTHERN BOULEVARD, ROSLYN, NY, 11576, US

(73) Assignee: NIPPON ELECTRIC GLASS CO. LTD.

(21) Appl. No.: 10/646,917

(22) Filed: Aug. 22, 2003

(30) Foreign Application Priority Data
Aug. 26, 2002 (JP) 245673/2002

(51) Int. Cl. C03C 3/066; C03C 14/00

(52) U.S. Cl. 501/79; 501/32

(57) ABSTRACT

In a dielectric material for a plasma display panel including 80-100 mass % glass powder and 0-20 mass % ceramic powder, the glass powder consists essentially of, in mass percent, 3-25% BaO, 25-60% ZnO, 15-35% B₂O₃, 3-30% SiO₂, 0.2-6% Li₂O, and 0-1.5% Al₂O₃.

This invention claims priority to prior Japanese patent application JP 2002-245673, the disclosure of which is incorporated herein by reference.

### BACKGROUND OF THE INVENTION

This invention relates to a dielectric material for a plasma display panel and, in particular, to a dielectric material for use in formation of a transparent dielectric layer formed on a front glass plate of a plasma display panel.

A plasma display panel is a self-emission flat display and has excellent characteristics, such as a light weight, a thin profile, and a wide viewing angle. In the plasma display panel, a display screen can easily be widened. Therefore, the plasma display panel attracts attention as one of most promising display devices.

The plasma display panel has a front glass substrate provided with a scanning electrode of Ag or Cr—Cu—Cr formed thereon to generate plasma discharge. On the scanning electrode, a transparent dielectric layer having a thickness of about 30-40 μm is formed to maintain the plasma discharge.

Generally, as the front glass substrate and a rear glass substrate of the plasma display panel, a soda lime glass or a high-strain-point glass is used. The dielectric layer is formed on the glass substrate by a method of firing a dielectric material in a temperature range of 500-600° C. so as to prevent deformation of the glass substrate and to suppress reaction with the electrode. In view of the above, as the dielectric material, use is made of lead-rich glass powder containing a large amount of lead, which is matched in coefficient of thermal expansion with the glass substrate and which can be fired at 500-600° C. Furthermore, the dielectric layer must be high in breakdown voltage and high in transparency. Therefore, the dielectric material is required to have characteristics such that bubbles are easily purged during firing and, even if bubbles are left, the bubbles are not large.

However, if the dielectric layer having a thickness of 30-40 μm is formed in a single firing step by the use of the dielectric material comprising the lead-rich glass powder, there is a tendency that the bubbles are hardly purged during firing, resulting in decrease in transparency. On the other hand, if the dielectric layer is formed as a lamination of a plurality of thin layers each having a reduced thickness so as to easily purge the bubbles, an increased number of firing steps is required, resulting in increase in cost.

In view of the above, the present inventors proposed a dielectric material comprising a BaO—ZnO—B₂O₃—SiO₂ glass in Japanese Unexamined Patent Publication No.2000-256039 (JP 2000-256039 A). The dielectric material is matched in coefficient of thermal expansion with the glass substrate and suppresses presence of residual bubbles in a dielectric layer as a fired film obtained by firing the dielectric material to assure high transmittance of the dielectric layer even if the dielectric layer having a thickness of 30-40 μm is formed in a single firing step.

Thus, the above-mentioned dielectric material provides the dielectric layer excellent in transparency because the bubbles are easily purged. However, the above-mentioned dielectric material is disadvantageous in that the glass and the electrode react with each other to produce bubbles which grow around the electrode to be left as large bubbles.

### SUMMARY OF THE INVENTION

It is therefore an object of this invention to provide a dielectric material for a plasma display panel, which is matched in coefficient of thermal expansion with a front glass substrate, which is capable of suppressing presence of residual bubbles in a dielectric layer as a fired film obtained by firing the dielectric material even if the dielectric layer having a thickness of 30-40 μm is formed in a single firing step, and which is capable of suppressing reaction with an electrode so as to form the dielectric layer high in transparency without large bubbles left around the electrode.

As a result of extensive studies, the present inventors have found out that, if a B₂O₃—ZnO glass containing an alkali metal component is used as a dielectric material for a plasma display panel, production of large bubbles around an electrode is suppressed. Based on the findings, this invention is proposed.

According to this invention, there is provided a dielectric material for a plasma display panel, comprising 80-100 mass % glass powder and 0-20 mass % ceramic powder, wherein the glass powder consists essentially of, in mass percent, 3-25% BaO, 25-60% ZnO, 15-35% B₂O₃, 3-30% SiO₂, 0.2-6% Li₂O, and 0-1.5% Al₂O₃.

### DESCRIPTION OF THE PREFERRED EMBODIMENT

As a dielectric material for a plasma display panel according to this invention, use is made of glass powder comprising a BaO—ZnO—B₂O₃—SiO₂ glass as a basic composition. The above-mentioned glass is relatively slow in viscosity change so that bubbles are easily purged from a dielectric layer as a fired film obtained by firing the dielectric material. Furthermore, the glass powder contains 0.2% or more Li₂O as an essential component in order to suppress production and growth of bubbles around an electrode. Furthermore, if the glass powder contains Li₂O, Na₂O, and K₂O as alkali metal components in a ratio of 1% or more in total, it is possible to reduce the risk of Ag or Cu as an electrode component being dissolved into the glass and to suppress the reaction between the glass and the electrode. Thus, the production and the growth of bubbles are further suppressed.

The glass powder used in this invention may be a crystallizable glass or a non-crystallizable glass as far as the glass consists essentially of, in mass percent, 3-25% BaO, 25-60% ZnO, 15-35% B₂O₃, 3-30% SiO₂, 0.2-6% Li₂O, and 0-1.5% Al₂O₃. If the content of ZnO and/or the alkali metal component is increased and the content of SiO₂ is decreased, the glass tends to become the crystallizable glass. Specifically, the crystallizable glass tends to be obtained if the glass consists essentially of, in mass percent, 3-25% BaO, 30-60% ZnO, 15-35% B₂O₃, 3-20% SiO₂, 0.2-6% Li₂O, and 0-1.5% Al₂O₃. The non-crystallizable glass tends to be obtained if the glass consists essentially of, in mass percent, 3-25% BaO, 25-45% ZnO, 15-35% B₂O₃, 10-30% SiO₂, 0.2-6% Li₂O, and 0-1.5% Al₂O₃.

If the crystallizable glass is used as the dielectric material, the following effect is expected. In case where the glass and the electrode react with each other to produce bubbles, reacting portions reacting with the electrode and the bubbles serve as crystal nuclei and fine crystals are deposited only around the reacting portions and the bubbles. Therefore, the production and the growth of bubbles around the electrode is suppressed.

However, if the crystallizable glass is used as the dielectric material, the crystals may be deposited during firing, making it difficult to obtain a transparent film. In order to prevent crystallization of the glass during firing, the ratio of BaO/(B₂O₃+SiO₂) is preferably adjusted to a value within a range between 0.1 and 0.8.

It is desired to use the crystallizable glass having a crystallization temperature between 600° C. and 800° C. The reason is as follows. If the crystallization temperature of the glass is excessively low, the crystals are deposited during firing so that a transparent fired film is difficult to obtain. On the other hand, if the crystallization temperature is excessively high, it is difficult to suppress the growth of bubbles produced by the reaction between the glass and the electrode.

On the other hand, in case where the non-crystallizable glass is used, the ratio of B₂O₃/SiO₂ is preferably adjusted to a value within a range between 0.8 and 2.0.

Now, description will be made about why the composition of the glass powder is restricted as described above.

BaO is a component which serves to prevent crystallization of the glass during firing of the dielectric material. The content of BaO is 3-25%, preferably 5-20%. If the content of BaO is less than 3%, crystals are deposited during firing so that a transparent fired film can not be obtained. If the content of BaO is more than 25%, the coefficient of thermal expansion becomes high and is not matched with that of the glass substrate.

ZnO is a component which serves to lower the softening point and to lower the coefficient of thermal expansion. The content of ZnO is 25-60%. If the crystallizable glass is used as the glass powder, the content of ZnO is preferably 35-55%, more preferably 44-55%. If the non-crystallizable glass is used as the glass powder, the content of ZnO is preferably 27-45%, more preferably 3044%. If the content of ZnO is less than 25%, the above-mentioned effects can not be obtained. If the content of ZnO is more than 60%, crystals are deposited during firing so that a transparent fired film can not be obtained.

B₂O₃ is a component forming a network of the glass. The content of B₂O₃ is 15-35%, preferably 17-33%. If the content of B₂O₃ is less than 15%, vitrification is difficult. On the other hand, if the content of B₂O₃ is more than 35%, the coefficient of thermal expansion is excessively high and is not matched with that of the glass substrate.

SiO₂ is a component forming a network of the glass. The content of SiO₂ is 3-30%. If the crystallizable glass is used as the glass powder, the content of SiO₂ is preferably 4-17%, more preferably 4-13%. If the non-crystallizable glass is used as the glass powder, the content of SiO₂ is preferably 10-27%, more preferably 13-24%. If the content of SiO₂ is less than 3%, crystals are deposited during firing so that a transparent fired film can not be obtained. If the content of SiO₂ is more than 30%, the softening point is excessively high so that firing at a temperature not higher than 600° C. is impossible.

Li₂O is a component which serves to suppress reaction between the glass and the electrode and to suppress the growth of bubbles produced around the electrode. The content of Li₂O is 0.2-6%, preferably 0.5-5%. If the content of Li₂O is less than 0.2%, the above-mentioned effects are not sufficiently achieved. On the other hand, if the content of Li₂O is more than 6%, crystals are easily deposited during firing so that a transparent fired film can not be obtained.

Addition of Li₂O alone may cause deposition of crystals during firing. Therefore, it is desired to additionally use Na₂O and K₂O each of which serves to suppress reaction between the glass and the electrode and to suppress the growth of bubbles produced around the electrode, like Li₂O. However, if the contents of Na₂O and K₂O are increased, crystals are easily deposited during firing so that a transparent fired film is difficult to obtain. In view of the above, the content of each of Na₂O and K₂O is preferably restricted to 6% or less. As regards the alkali metal components, the total content of Li₂O, Na₂O, and K₂O is 1-12%, preferably 2-11%. If the total content is less than 1%, it is difficult to achieve the effects of suppressing the reaction between the glass and the electrode and of suppressing the growth of bubbles produced around the electrode. On the other hand, if the total content is more than 12%, crystals are easily deposited during firing so that a transparent fired film is difficult to obtain.

Al₂O₃ is a component which serves to prevent crystallization of the glass during firing of the dielectric material. The content of Al₂O₃ is 0-1.5%, preferably, 0-1%. If the content of Al₂O₃ is more than 1.5%, the softening point is elevated so that firing at a temperature not higher than 600° C. is impossible.

In order to prevent crystallization of the glass during firing of the dielectric material, the ratio of BaO/(B₂O₃+SiO₂) desirably falls within a range between 0.1 and 0.8. If the above-mentioned ratio is smaller than 0.1, crystals are deposited during firing of the dielectric material so that a transparent fired film is difficult to obtain. If the above-mentioned ratio is greater than 0.8, the coefficient of thermal expansion of the dielectric material becomes large and is not matched with that of the glass substrate. More preferably, the above-mentioned ratio falls within a range between 0.15 and 0.6.

If the non-crystallizable glass is used as the dielectric material, the ratio of B₂O₃/SiO₂ is preferably adjusted to a value within a range between 0.8 and 2.0 in order to further suppress the growth of bubbles produced by reaction between the glass and the electrode. If the above-mentioned ratio is smaller than 0.8, the softening point becomes excessively high and firing is difficult at a temperature not higher than 600° C. If the above-mentioned ratio is greater than 2.0, crystals are easily deposited during firing so that a transparent fired film can not be obtained. The above-mentioned ratio preferably falls within a range between 0.9 and 1.7, more preferably between 1.0 and 1.5.

In addition to the above-mentioned components, other components may be added within a range such that the effects of this invention are not spoiled. For example, in order prevent the crystallization temperature from being lowered, La₂O₃ or Y203 may be added. In order to improve water resistance and chemical resistance, alkaline earth metal oxide, such as MgO, CaO, and SrO, Ta₂O₅, SnO₂, ZrO₂, TiO₂, or Nb₂O₅ may be added. In order to stabilize the glass, P₂O₅ may be added. The content of other components must be restricted to 15% or less, preferably 10% or less in total.

PbO is a component which serves to lower the softening point of the glass. However, it is preferable not to include PbO because the presence of PbO makes it difficult to purge the bubbles during firing of the dielectric layer and to obtain a transparent fired film.

For the purpose of suppressing the production of bubbles and of maintaining the shape, the dielectric material for a plasma display panel according to this invention may contain up to 20% ceramic powder in addition to the glass powder mentioned above. If the content of the ceramic powder is more than 20%, visible light is scattered so that a transparent fired film is difficult to obtain. The content of the ceramic powder is preferably 10% or less. As the ceramic powder, use may be made of one kind or a combination of two or more kinds of ceramic materials, such as alumina, zirconia, zircon, titania, cordierite, mullite, silica, willemite, tin oxide, and zinc oxide. In order to avoid the decrease in transparency of the dielectric layer as a result of introduction of the ceramic powder, a part or a whole of the ceramic powder may be formed into a spherical shape. Herein, the “spherical shape” is intended to represent a powder particle having no angled portion on the surface of the particle and exhibiting radius deviation within a range of +20% as measured from the center of the particle to every point throughout an entire surface of the particle. The ceramic powder desirably has an average particle size of 5.0 μm or less and a maximum particle size of 20 μm or less.

In the dielectric material for a plasma display panel according to this invention, the glass powder preferably has a granularity given by an average particle size D₅₀ of 3.0 μm or less and a maximum particle size Dₘₐₓ of 20 μm or less. If either the average particle size or the maximum particle size exceeds the above-mentioned upper limit, large bubbles tend to be left in the fired film.

The dielectric material for a plasma display panel according to this invention may be used as either of a transparent dielectric member formed on a front plate and an address dielectric member formed on a rear plate. The dielectric material according to this invention may be used for various other applications.

Next, description will be made about how to use the dielectric material for a plasma display panel according to this invention. For example, the dielectric material of this invention may be used in the form of a paste or a green sheet.

If the dielectric material is used in the form of the paste, thermoplastic resin, a plasticizer, and a solvent are used together with the dielectric material mentioned above. The ratio of the glass powder in the paste is generally on the order of 30-90 mass %.

The thermoplastic resin is a component which serves to improve a film strength after dried and to provide flexibility. The content of the thermoplastic resin is generally on the order of 0.1-20 mass %. As the thermoplastic resin, use may be made of polybutyl methacrylate, polyvinyl butyral, polymethyl methacrylate, polyethyl methacrylate, and ethyl cellulose. These substances may be used alone or in combination.

The plasticizer is a component which serves to control a drying rate and to provide flexibility to a dry film. The content of the plasticizer is generally on the order of 0-10 mass %. As the plasticizer, use may be made of butyl benzyl phthalate, dioctyl phthalate, diisooctyl phthalate, dicapryl phthalate, and dibutyl phthalate. These substances may be used alone or in combination.

The solvent is used to form a paste from the material. The content of the solvent is generally on the order of 10-30 mass %. As the solvent, use may be made of terpineol, diethylene glycol monobutyl ether acetate, and 2,2,4-trimethyl-1,3-pentadiol monoisobutyrate. These substances may be used alone or in combination.

The paste is produced by preparing the dielectric material, the thermoplastic resin, the plasticizer, the solvent, and so on and by kneading these substances at a predetermined ratio.

By the use of the above-mentioned paste, the dielectric layer is formed in the following manner. At first, the paste is applied by screen printing or batch coating to form an application layer having a predetermined thickness. Thereafter, the application layer is dried into a dry film. Then, the dry film is fired to obtain the dielectric layer of a predetermined thickness.

If the dielectric material of this invention is used in the form of the green sheet, the thermoplastic resin and the plasticizer are used together with the dielectric material mentioned above. The ceramic powder may be added if necessary.

The ratio of the dielectric material in the green sheet is generally on the order of 60-80 mass %.

As the thermoplastic resin and the plasticizer, use may be made of similar substances to those used in preparing the paste. The mixing ratio of the thermoplastic resin is generally on the order of 5-30 mass %. The mixing ratio of the plasticizer is generally on the order of 0-10 mass %.

Description will be made of a typical method of producing the green sheet. At first, preparation is made of the dielectric material, the thermoplastic resin, the plasticizer, and so on. To these materials, a main solvent such as toluene and an auxiliary solvent such as isopropyl alcohol are added to obtain a slurry. The slurry is applied on a film such as polyethylene terephthalate (PET) by the doctor blade method and subjected to sheet forming. After the sheet forming, the slurry is dried to remove the solvents. Thus, the green sheet is obtained.

The green sheet obtained as mentioned above is thermocompression-bonded to form an application layer at a position where a glass layer is to be formed. Thereafter, the application layer is fired in the manner similar to the above-mentioned paste to obtain the dielectric layer.

In the foregoing description, the processes using the paste and the green sheet are described as a dielectric forming method. However, without being limited to the above-mentioned processes, the dielectric material for a plasma display panel according to this invention is applicable to various other methods, such as a photosensitive paste process and a photosensitive green sheet process.

### EXAMPLES

Hereinafter, this invention will be described in conjunction with specific examples.

Tables 1 and 2 show examples (Samples Nos. 1-12) of this invention. Table 3 shows comparative examples (Samples Nos. 13-15). In each of Samples Nos. 1-8, 13, and 14, a crystallizable glass was used. In each of Samples Nos. 9-12 and 15, a non-crystallizable glass was used.

Each sample was prepared in the following manner. At first, various oxides and carbonates as glass raw materials were blended to obtain the compositions shown in Tables 1 and 2 and uniformly mixed. Thereafter, the mixture was put in a platinum crucible and melted at 1300° C. for two hours to obtain a molten glass. The molten glass was formed into a thin plate. The thin plate was pulverized and classified to obtain the sample comprising glass powder having an average particle size D₅₀ of 3.0 μm and a maximum particle size Dₘₐₓ of 20 μm. For each sample, the softening point and the crystallization temperature of the glass were measured. Sample No. 6 was obtained by mixing alumina powder with the glass powder of Sample No. 5. The average

TABLE 1

| | Examples | | | | | |
|---|---|---|---|---|---|---|
| | No. 1 | No. 2 | No. 3 | No. 4 | No. 5 | No. 6 |
| glass composition (mass %) | | | | | | |
| BaO | 12 | 9 | 13 | 15 | 13 | 13 |
| ZnO | 50 | 52 | 47 | 45 | 48 | 48 |
| B₂O₃ | 24 | 26 | 25 | 30 | 27 | 27 |
| SiO₂ | 8 | 9 | 8 | 6 | 8 | 8 |
| Li₂O | 3 | 2 | 2 | 2 | 2 | 2 |
| Na₂O | — | — | 1 | 2 | 2 | 2 |
| K₂O | — | 2 | 1 | — | — | — |
| Al₂O₃ | 1 | — | 1 | — | — | — |
| TiO₂ | 2 | — | 1 | — | — | — |
| ZrO₂ | — | — | 1 | — | — | — |
| La₂O₃ | — | — | — | — | — | — |
| PbO | — | — | — | — | — | — |
| ceramic powder | — | — | — | — | — | alumina |
| content (mass %) | — | — | — | — | — | 10 |
| softening point (° C.) | 553 | 557 | 557 | 564 | 562 | 567 |
| crystallization temperature | 620 | 623 | 620 | 630 | 626 | 628 |
| (° C.) | | | | | | |
| coefficient of thermal | 70.0 | 69.3 | 72.2 | 74.6 | 71.5 | 71.3 |
| expansion (× 10⁻⁷/° C.) | | | | | | |
| firing temperature (° C.) | 560 | 560 | 560 | 570 | 570 | 570 |
| film thickness (μm) | 30 | 30 | 31 | 28 | 29 | 31 |
| transmittance (%) | 78 | 79 | 78 | 80 | 79 | 73 |
| number of large bubbles | | | | | | |
| fired film | 3 | 1 | 1 | 0 | 2 | 0 |
| around electrode | 0 | 1 | 2 | 1 | 1 | 0 |

TABLE 2

| | Examples | | | | | |
|---|---|---|---|---|---|---|
| | No. 7 | No. 8 | No. 9 | No. 10 | No. 11 | No. 12 |
| glass composition | | | | | | |
| (mass %) | | | | | | |
| BaO | 11 | 11 | 9 | 8 | 8 | 9 |
| ZnO | 50 | 45 | 37 | 33 | 33 | 35 |
| B₂O₃ | 23 | 19 | 25 | 24 | 24 | 26 |
| SiO₂ | 7 | 12 | 20 | 19 | 19 | 18 |
| Li₂O | 1 | 1 | 2 | 2 | 2 | 1 |
| Na₂O | 3 | 3 | 1 | 5 | 5 | 8 |
| K₂O | — | — | 6 | 1 | 1 | 1 |
| Al₂O₃ | 1 | 1 | 2 | — | — | — |
| TiO₂ | — | — | — | — | — | 2 |
| ZrO₂ | 1 | — | — | — | — | — |
| La₂O₃ | 3 | 8 | — | 8 | 8 | — |
| PbO | — | — | — | — | — | — |
| ceramic powder | — | — | — | — | alumina | — |
| content (mass %) | — | — | — | — | 10 | — |
| softening point (° C.) | 573 | 587 | 568 | 568 | 575 | 570 |
| crystallization | 640 | 685 | — | — | — | — |
| temperature | | | | | | |
| (° C.) | | | | | | |
| coefficient of thermal | 72.4 | 70.3 | 78.4 | 79.4 | 79.1 | 79.3 |
| expansion (× 10⁻⁷/ | | | | | | |
| ° C.) | | | | | | |
| firing temperature | 580 | 590 | 570 | 570 | 570 | 570 |
| (° C.) | | | | | | |
| film thickness (μm) | 30 | 31 | 31 | 29 | 30 | 30 |
| transmittance (%) | 78 | 78 | 77 | 78 | 73 | 78 |
| number of large | | | | | | |
| bubbles | | | | | | |
| fired film | 2 | 0 | 2 | 2 | 1 | 2 |
| around electrode | 0 | 1 | 2 | 1 | 1 | 2 |

TABLE 3

Comparative Examples

| | No. 13 | No. 14 | No. 15 |
|---|---|---|---|
| glass composition | | | |
| (mass %) | | | |
| BaO | 1 | 9 | 28 |
| ZnO | 55 | 48 | 33 |
| B₂O₃ | 25 | 25 | 22 |
| SiO₂ | 11 | 10 | 7 |
| Li₂O | 5 | 7 | — |
| Na₂O | 3 | — | — |
| K₂O | — | — | — |
| Al₂O₃ | — | 1 | — |
| TiO₂ | — | — | — |
| ZrO₂ | — | — | — |
| La₂O₃ | — | — | — |
| PbO | — | — | 10 |
| ceramic powder | — | — | — |
| content (mass %) | — | — | — |
| softening point (° C.) | 556 | 550 | 595 |
| crystallization temperature | 581 | 581 | — |
| (° C.) | | | |
| coefficient of thermal | 65.0 | 68.2 | 77.0 |
| expansion (×10⁻⁷/° C.) | | | |
| firing temperature (° C.) | 560 | 560 | 580 |
| film thickness (μm) | 30 | 31 | 32 |
| transmittance (%) | 67 | 65 | 80 |
| number of large bubbles | | | |
| fired film | 1 | 3 | 2 |
| around electrode | 2 | 1 | 10 |

particle size D₅₀ and the maximum particle size Dₘₐₓ were confirmed by the use of a laser diffraction particle size analyzer. The alumina powder had the average particle size of 1.0 μm and the maximum particle size of 10 μm and had a spherical shape.

The samples thus obtained were evaluated for the coefficient of thermal expansion, the film thickness after firing, the spectral transmittance at 550 nm, the number of large bubbles having a diameter not smaller than 30 μm and left in the fired film or around the electrode. The results are shown in Tables 1 through 3.

As seen from Tables 1 and 2, each of Samples Nos. 1 to 12 as examples of this invention had a softening point between 553° C. and 587° C. Each of Samples Nos. 1-8 using the crystallizable glass had a crystallization temperature between 620° C. and 685° C. The coefficient of thermal expansion was between 69.3×10⁻⁷/° C. and 79.4×10⁻⁷/° C. The film thickness of the fired film was between 28 and 31 μm. The transmittance at 550 nm was 73% or more and, therefore, the fired film was transparent. The number of large bubbles left in the fired film was as small as 3 or less. The number of large bubbles left around the electrode was as small as 2 or less.

On the other hand, each of Samples Nos. 13 and 14 as comparative examples had the crystallization temperature as low as 581° C. Therefore, crystals were deposited during firing so that a transparent dielectric layer was not obtained and the transmittance was not higher than 67%. Sample No. 15 as a comparative example did not contain an alkali metal component so that the number of large bubbles around the electrode was as large as 10.

The softening point and the crystallization temperature of the glass were measured by the use of a macro-type differential thermal analyzer as a fourth inflection point and a heat peak, respectively. The coefficient of thermal expansion was obtained in the following manner. Each sample was powder-pressed and fired. Thereafter, the sample was polished into a cylindrical shape having a diameter of 4 mm and a length of 40 mm. The coefficient of thermal expansion was measured in accordance with JIS (Japanese Industrial Standard) R3102. Then, the value within a temperature range of 30 to 300° C. was obtained. The film thickness after firing, the transmittance, and the number of large bubbles were measured in the following manner. At first, each sample was mixed into a 5% terpineol solution of ethyl cellulose and kneaded by use of a three-roll mill to form a paste. Then, the paste was applied by screen printing onto a high-strain point glass plate (having a coefficient of thermal expansion of 83×10⁻⁷/° C.) so as to obtain a fired film of about 30 μm. The glass plate with the past applied thereon was put into an electric furnace and held for 10 minutes at the firing temperature shown in Tables 1 through 3. The thickness of the fired film thus obtained was measured by use of a digital micrometer. The transmittance was measured for the wavelength of 550 nm by the use of a spectrophotometer with an integration sphere by setting the glass plate with the fired film at a sample side of the spectrophotometer. The number of large bubbles in the fired film was obtained by observing the surface of the fired film using a stereoscope (×30 magnification) and counting the number of large bubbles having a diameter of 30 μm or more within an area of 3 cm×4 cm. The number of large bubbles around the electrode was obtained as follows. On a high-strain-point glass plate with an Ag electrode (having the electrode width of 100 μm and the electrode distance of 500 μm), a fired film was formed in the manner similar to that mentioned above. An electrode portion was observed by the stereoscope (×30 magnification) and the number of large bubbles having a diameter of 30 μm or more was counted within an area of 3 cm×4 cm.

As described above, the dielectric material for a plasma display panel according to this invention has a coefficient of thermal expansion matched with that of the glass substrate, allows the bubbles to be easily purged even if fired at a temperature around the softening point, and suppresses reaction with the electrode so that large bubbles are hardly produced around the electrode. Thus, a transparent dielectric layer excellent in transparency and high in breakdown voltage can be obtained.

As described above, the dielectric material is advantageously used for a plasma display panel.

While this invention has thus far been disclosed in conjunction with several embodiments and examples thereof, it will be readily possible for those skilled in the art to put this invention into practice in various other manners.

What is claimed is:

1. A dielectric material for a plasma display panel comprising 80-100 mass % glass powder and 0-20 mass % ceramic powder, wherein:
the glass powder consists essentially of, in mass percent, 3-25% BaO, 25-60% ZnO, 15-35% B₂O₃, 3-30% SiO₂, 0.2-6% Li₂O, and 0-1.5% Al₂O₃.

2. A dielectric material according to claim 1, wherein:
the glass powder contains, in mass percent, 1-12% Li₂O+Na₂o+K₂O.

3. A dielectric material according to claim 1, wherein:
the glass powder does not substantially contain PbO.

4. A dielectric material according to claim 1, wherein:
the glass powder is a crystallizable glass consisting essentially of, in mass percent, 3-25% BaO, 30-60% ZnO, 15-35% B₂O₃, 3-20% SiO₂, 0.2-6% Li₂O, and 0-1.5% Al₂O₃.

5. A dielectric material according to claim 4, wherein:
the ratio of BaO/(B₂O₃+SiO₂) in the glass powder falls within a range between 0.1 and 0.8.

6. A dielectric material according to claim 4, wherein:
the glass powder has a crystallization temperature between 600° C. and 800° C.

7. A dielectric material according to claim 1, wherein:
the glass powder is a non-crystallizable glass consisting essentially of, in mass percent, 3-25% BaO, 25-45% ZnO, 15-35% B₂O₃, 10-30% SiO₂, 0.2-6% Li₂O, and 0-1.5% Al₂O₃.

8. A dielectric material according to claim 7, wherein:
a ratio of B₂O₃/SiO₂ in the glass powder falls within a range between 0.8 and 2.0.

9. A dielectric material according to claim 1, wherein:
the glass powder has a granularity given by an average particle size D₅₀ of 3.0 μm or less and a maximum particle size Dₘₐₓ of 20 μm or less.
